(19) United States
(12) Patent Application Publication
(10) Pub. No.: US 2025/0276853 A1
(43) Pub. Date: Sep. 4, 2025

(54) NO LUBE CONVEYOR CHAIN

(71) Applicant: Frost Incorporated, Grand Rapids, MI (US)

(72) Inventors: Charles J. Deschaine, Walker, MI (US); Richard A Hyvarinen, Hastings, MI (US)

(73) Assignee: Frost Incorporated, Grand Rapids, MI (US)

(21) Appl. No.: 19/063,754

(22) Filed: Feb. 26, 2025

Related U.S. Application Data
(60) Provisional application No. 63/559,820, filed on Feb. 29, 2024.

(51) Int. Cl. B65G 17/38

(52) U.S. Cl. CPC B65G 17/38; B65G 2201/0202; B65G 2812/02376

(57) ABSTRACT

Bakery baking and proofing no lube conveyor chain with high temperature “all polymeric” load and guide wheels rotating on fixed or rotating axles. The chain consists of metal links with the use of specialized polymeric bushings and “all polymeric” wheels to eliminate metal to metal contact.

### CLAIM OF PRIORITY

This application claims priority to application Ser. No. 63/559,820 filed Feb. 29, 2024, entitled NO LUBE CONVEYOR CHAIN.

### FIELD AND BACKGROUND OF THE INVENTION

The present invention relates to the field of conveyors, and conveyor chains used to drive conveyors. Efforts are continually underway to improve the longevity of conveyor chains. Some of these efforts involve using chains with hardened coatings on wear surfaces. Some of these chains have been proposed for use in the bakery industry where lubrication and wear debris from the conveyor chains are considered contaminants to be avoided to the extent possible. To applicant's knowledge, none of these efforts have met with any significant success in the bakery industry.

U.S. Pat. No. 7,063,207 (division of U.S. Pat. No. 6,666,328) to Sykora issued Jun. 20, 2006, entitled long wear conveyor assembly, discloses a chain conveyor assembly having the combination of a polymeric material and a hard diamond-like coating at the frictional interface of the chain links. The conveyor chain preferably includes male and female links connected to one another by connector pins. The shaft of each connector pin is coated with a diamond-like coating having high hardness, low friction and low wear characteristics. Opposite ends of the connector pins are connected to the female link while the shaft of the connector pin passes through the male link. A polymeric bushing is fitted to the male link in engagement with the shaft of the connector pin. Accordingly, relative movement between the links occurs at the interface of the diamond like coated connector pin and the polymeric bushing. The chain is carried by trolleys, each of which is connected to a male link, and the trolleys are suspended from bearings which ride on a conveyor track.

U.S. Pat. Nos. 7,086,525 B2 and 6,968,943 to Kilby disclose conveyor chains of the type utilized in commercial ovens and proofers. They point out “lack of lubrication” as a problem and utilize wheels with self-lubricating and/or anti friction bearings. The internal volume of the bearing is from between about 1% to about 100% filled with a high temperature solid lubricant selected from the group consisting of molybdenum disulfide, graphite, polytetrafluoroethylene polymer (PTFE) and a bearing grease selected from the group consisting of perflouropolyethers (PFPE), polyapha-olefin (PAO), polyphenylethers (PPE), synthetic esters, and silicon based greases. The bearing seal is selected from the group consisting of labyrinth fiberglass reinforced PTFE seals; viton rubber seals with stainless steel backings; and stainless-steel shields with a 00.001″ gap between the inner races.

Balls or rollers selected from the group consisting of silicon nitride, alumina, zirconia, silicon carbide, 52100 bearing steel, 440C stainless steel, BG-42 high temperature corrosion resistant tool steel, M50 high temperature tool steel with sphericity <48 μin., are also used. The pivoting components in the chain are provided with plain bearings and/or antifriction coating which also function to extend the service life of the conveyor chains.

Lubricated chains having “all polymeric” trolley wheels are used in the poultry and meat industries in non-heated environments. These chains have to be frequently washed with bleach or like cleaning solutions. The “all polymeric” trolley wheels are used in these lubricated chains instead of steel wheels with steel bearing bushings because the “all polymeric” wheels are not subject to corrosion in the washing environment like the metal wheels are.

### SUMMARY OF THE INVENTION

The present invention comprises a conveyor, a “no lube” conveyor chain for a conveyor, and method of using same, in which the load wheels and guide wheels on the chain are “all polymeric” wheels rotating on fixed or rotating axles. They are “all polymeric” in that there are no metal rims or metal bearings, or other metal items used in the bearings. In addition to the “all polymeric” wheels, it is preferred that specialized polymeric bushings are used where chain links are connected, to eliminate metal to metal contact in the chain.

### BRIEF DESCRIPTION OF THE DRA WINGS

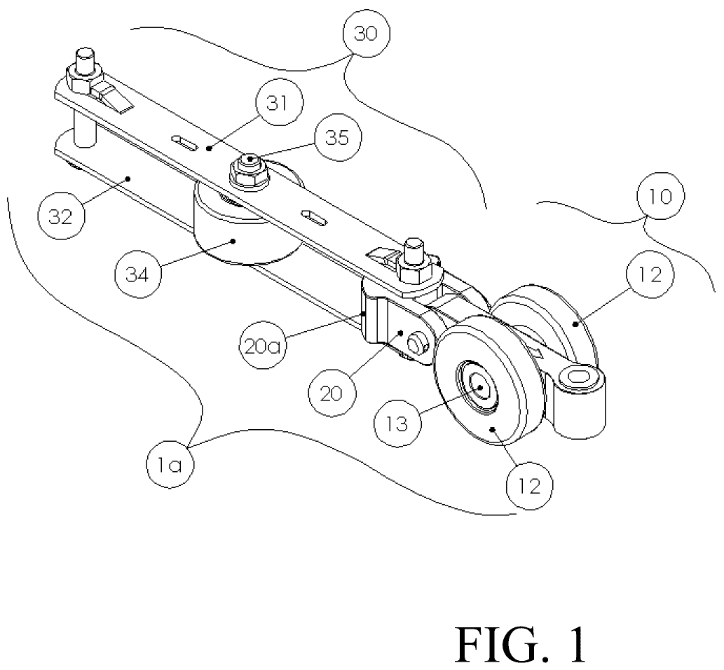

FIG. 1 is a perspective view of a combined load link, drive link, and guide link;

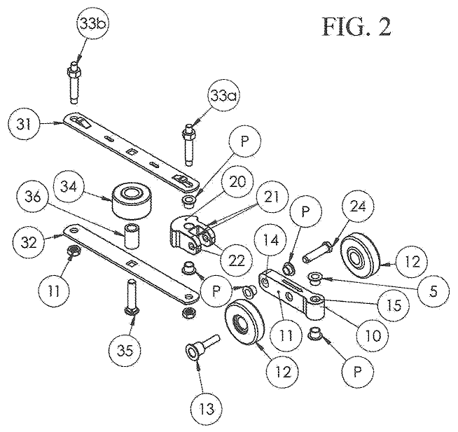

FIG. 2 is an exploded perspective view of the combined load link, drive link and guide link;

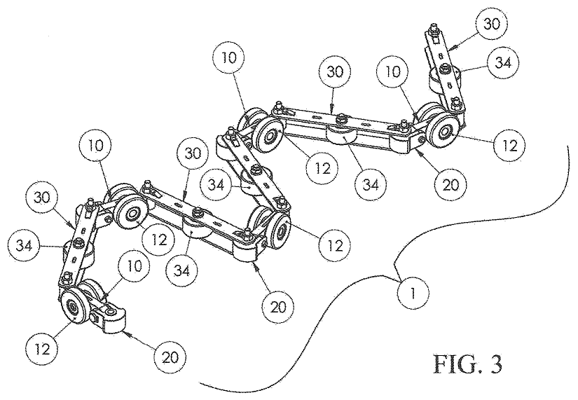

FIG. 3 is an elevated perspective view of a multi-link section of the conveyor chain; and

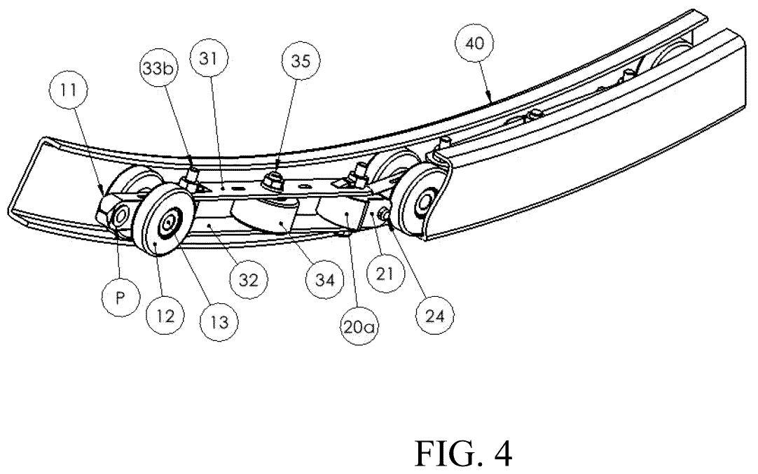

FIG. 4 is a view of a section of a conveyor equipped with the conveyor chain of the present invention.

### DESCRIPTION OF THE PREFERRED EMBODIMENTS

In the preferred embodiment, the “no lube” chain 1 of the present invention comprises a plurality of link segments 1a, each of which comprises a load link 10, drive link 20 and guide link 30. (FIGS. 1, 2) Load link 10 comprises a vertically oriented steel link body 11 carried on two parallel vertically oriented “all polymeric” carrier wheels 12 on either side of said load link, which roll on a fixed axel or with a rotating axel 13 extending through an axel opening in link body 11. It is preferred that the poly wheels 12 rotate on fixed axels. If the axels are to rotate with poly wheels 12, appropriate bushings are used at each of its ends. Load link 10 comprises a lateral coupling opening 14 at its “tail end,” and a vertical link coupling opening 15 at its leading end, both openings fitted with poly bushing inserts (P) at each end. Coupling opening 14 facilitates coupling to drive link 20 directly behind load link 10. Coupling opening 15 facilitates coupling load link 10 to a guide link so directly ahead of it.

Drive link 20 is made of steel and is “U” shaped, opening forwardly to receive the tail end of load link 10 between the two legs 21 of its “U.” It has a corresponding coupling opening 22 in each of its legs 21, which are positioned to mate with coupling opening 14 in the tail of load link 10. A coupling pin 24 passes through the mating openings 14 and 22 to couple drive link to load link. Drive link 20 has a vertical coupling opening 23 through the base of its “U.” This facilitates its coupling to the following guide link 30. Both coupling openings are provided with poly bushing inserts (P) at each end. Drive link 20 is configured to be engaged by the drive mechanism of the conveyor it is positioned in, which facilitates advancing “no lube” chain 1 through the conveyor. Both the load and drive link pass the pull test of 10,000 lbs.

Guide link 30 is comprised of a long top flat guide link plate 31 and a matching bottom flat guide link plate 32. Plates 31 and 32 are held in spaced parallel opposition by an intervening shoulder stud 33a at the lead end of guide link 30 and a shoulder stud 33b at the tail end. Positioned between the top and bottom plates, approximately midway between the ends of guide link 30.

Guide wheel 34 rotates on a fixed or with a rotating axel 36 extending through the center of poly wheel 34 and fixed to or rotates on connecting bolt 35 which connects and clamps top and bottom plates 31 and 32 together. It is preferred that the poly wheel 34 rotates on a fixed axel 36. If axel 36 is to rotate with “all polymer” guide wheel 34, optional poly bushings would be provided at the ends of connecting bolt 35 at its connection to top and bottom plates (31, 32).

FIG. 4 shows conveyor chain 1 traveling in an enclosed steel track 40 of the type used in the bakery industry. Track 40 can be a straight track, but it also has to be curved in places in the bakery oven. As can be seen above, links 10, 20 and 30 are connected such that they will accommodate curved portions of track 40 as shown in FIG. 4.

The steel components referred to above, including enclosed bakery conveyor track 40, can be stainless steel.

### The “all Polymeric” Wheels

While equivalent polymerics can be substituted, three preferred classes of thermoplastic polymerics for use in the “all polymeric” wheels include polytetrafluoroethylene (PTFE), polyether ether ketone (PEEK), and polyamide-imide (PAI). Preferably, a high temperature polymeric is used for the “all polymeric” carrier wheels 12 and guide wheels 34, including bakery baking ovens. By “high temperature polymeric,” we mean polymerics that will exhibit long term service temperatures of about 480° F., short term service temperatures of about 570° F., and short-term ambient temperatures of about 599° F.

For use in bakery chains and similar food processing environments, the preferred polymers exhibit good pressure velocity and Load ratings, e.g., 0.001-0.002 initial wear depth. Other preferred properties include:
density: 1.28 g/cm3
saturation with moisture absorption at 74° F./50% r. h.: 0.3 weight % saturation with water: 0.5 weight %

### Mechanical Properties:

flexural modulus: 522 000 PSI
flexural strength: 20 300 PSI
max. permissible surface pressure at 68° F.: 17 4 00 PSI
Shore D hardness: 83

While the above describes a preferred embodiment high temperature polymeric for making the “all polymeric” wheels for use in the baking ovens of bakeries, lower temperature polymerics can be used in lower temperature environments where a “no lube” chain is required. A polymer used for bakery proofing ovens for example need only tolerate 120° F. The following are the properties of one such preferred lower temperature environment polymeric for the “all polymeric” carrier and guide wheels:

### General Properties:

density: 1.46 g/cm3
saturation with moisture absorption at 23° C./50% r. h.: 0.2 weight % saturation with water: 1.3 weight %

### Mechanical Properties:

flexural modulus: 2300 MPa
flexural strength: 88 MPa
max. permissible surface pressure at 20° C.: 28 MPa
Shore D hardness: 76

### Thermal Properties:

highest long term service temperature: 90° C.
highest short term service temperature: 110° C.
highest short term ambient temperature: 110° C.

### CONCLUSION

Thus, the chain of the present invention can be used in enclosed track systems in bakeries and similar industries where the chain can be subject to high moisture or high heat environments without the use of applied lubricants.

The elimination of the use of added lubricants can be high cost and lead to a buildup in the system that requires high levels of maintenance. The elimination of the use of these lubricants can be significant cost savings in both no longer having a need to purchase the lubricant itself and greatly decrease the cost of maintenance and down time. Also, by using an “all polymeric” wheel the wear on the track is greatly reduced, increasing the life of the track and time between costly track replacement.

1. A “no lube” conveyor comprising: a non-lubricated conveyor chain and non-lubricated track in which said non-lubricated chain travels;
said non-lubricated chain comprising a plurality of link segments, each of which comprises a load link, a drive link, and a guide link;
said load link comprising a load link body extending from a tail end and a leading end; said load link body being carried on two parallel vertically oriented all polymeric load wheels on either side of said load link body, which roll in said track on a fixed axel extending through an axel opening in said load link body; said load link body comprising a lateral coupling opening at its tail end adapted to couple to said drive link, and a vertical link coupling opening at its leading end adapted to couple to said guide link;
said drive link comprising a “U” shaped body, having a base with two spaced legs extending forwardly and adapted to receive and couple to said tail end of said load link between said two legs; said base of said U being adapted to couple to said guide link;
said guide link being comprised of vertically spaced top and bottom guide link plates carrying a horizontally oriented all polymeric guide wheel rotating on a fixed axel extending vertically between said top and bottom guide plates through an axel receiving opening in said all polymeric guide wheel;
said guide link top and bottom plates extending forward form said guide wheel to a forward end where they are adapted to embrace top and bottom and couple with said base of said drive wheel; said top and bottom guide plates extending rearwardly from said guide wheel to a tail end where they are adapted to couple with the leading end of said load link.

2. The no-lube conveyor of claim 1 in said coupling between said load link and said drive link, and said coupling between said drive link and said guide link and said guide link and said load link are all fitted with polymeric bushings to prevent contact between said coupled links.

3. The no-lube conveyor of claim 2 in which said track is enclosed.

4. The no-lube conveyor of claim 3 in which said track is made of stainless steel.

5. The no-lube conveyor of claim 4 in which said all polymeric load wheels, guide wheels and polymeric bushings are made of high temperature polymer.

6. The no-lube conveyor of claim 2 in which said all polymeric load wheels, guide wheels and polymeric bushings are made of high temperature polymer.

7. The no-lube conveyor of claim 1 in which said all polymeric load wheels and guide wheels are made of high temperature polymer.

8. A “no lube” conveyor comprising: a non-lubricated conveyor chain and non-lubricated track in which said non-lubricated chain travels;
said non-lubricated chain comprising a plurality of link segments, each of which comprises a load link, a drive link, and a guide link;
said load link comprising a load link body extending from a tail end and a leading end; said load link body being carried on two parallel vertically oriented all polymeric load wheels on either side of said load link body, which roll in said track on an axle extending through an axel opening in said load link body which rotates with said all polymeric load wheel with polymeric bushings at its ends; said load link body comprising a lateral coupling opening at its tail end adapted to couple to said drive link, and a vertical link coupling opening at its leading end adapted to couple to said guide link;
said drive link comprising a “U” shaped body, having a base with two spaced legs extending forwardly and adapted to receive and couple to said tail end of said load link between said two legs; said base of said U being adapted to couple to said guide link;
said guide link being comprised of vertically spaced top and bottom guide link plates carrying a horizontally oriented all polymeric guide wheel rotating on a fixed axel extending vertically between said top and bottom guide plates through an axel receiving opening in said all polymeric guide wheel;
said guide link top and bottom plates extending forward form said guide wheel to a forward end where they are adapted to embrace top and bottom and couple with said base of said drive wheel; said top and bottom guide plates extending rearwardly from said guide wheel to a tail end where they are adapted to couple with the leading end of said load link.

9. The “no lube” conveyor of claim 8 in which said guide wheel also rotates with its axel extending through said axel opening in said guide, fitted with polymeric bushings at its ends.

10. The no-lube conveyor of claim 9 in which said track is enclosed.

11. The no-lube conveyor of claim 10 in which said track is made of stainless steel.

12. The no-lube conveyor of claim 11 in which said all polymeric load wheels, guide wheels and polymeric bushings are made of high temperature polymer.

13. The no-lube conveyor of claim 9 in which said all polymeric load wheels, guide wheels and polymeric bushings are made of high temperature polymer.

14. The no-lube conveyor of claim 1 in which said all polymeric load wheels and guide wheels are made of high temperature polymer.

15. A method of proofing bread and liked goods for baking comprises employing a “no lube” conveyor comprising: a non-lubricated bakery conveyor chain and non-lubricated track in which said non-lubricated bakery chain travels; employing all polymeric load wheels and all polymeric guide wheels in said bakery chain and refraining from lubricating chain and said track and advancing said non-lubricated bakery chain on said non-lubricated track through a proofing oven.

16. A method of baking bread and liked goods in a high temperature baking oven comprising employing a “no lube” conveyor comprising: a non-lubricated bakery conveyor chain and non-lubricated track in which said non-lubricated bakery chain travels; employing all polymeric load wheels and all polymeric guide wheels in said bakery chain which are made from high temperature polymers, and refraining from lubricating said chain and said track and advancing said non-lubricated bakery chain on said non-lubricated track through a high temperature bakery oven.

17. A “no lube” conveyor chain comprising: a plurality of link segments, each of which comprises a load link, a drive link, and a guide link;
said load link comprising a load link body extending from a tail end and a leading end; said load link body being carried on two parallel vertically oriented all polymeric load wheels on either side of said load link body, which roll in a track on a fixed axel extending through an axel opening in said load link body; said load link body comprising a lateral coupling opening at its tail end adapted to couple to said drive link, and a vertical link coupling opening at its leading end adapted to couple to said guide link;
said drive link comprising a “U” shaped body, having a base with two spaced legs extending forwardly and adapted to receive and couple to said tail end of said load link between said two legs; said base of said U being adapted to couple to said guide link;
said guide link being comprised of vertically spaced top and bottom guide link plates carrying a horizontally oriented all polymeric guide wheel rotating on a fixed axel extending vertically between said top and bottom guide plates through an axel receiving opening in said all polymeric guide wheel;
said guide link top and bottom plates extending forward form said guide wheel to a forward end where they are adapted to embrace top and bottom and couple with said base of said drive wheel;
said top and bottom guide plates extending rearwardly from said guide wheel to a tail end where they are adapted to couple with the leading end of said load link.

18. The no-lube conveyor chain of claim 17 in which said coupling between said load link and said drive link, and said coupling between said drive link and said guide link and said guide link and said load link are all fitted with polymeric bushings to prevent contact between said coupled links.

19. The no-lube conveyor chain of claim 18 in which said all polymeric load wheels, guide wheels and polymeric bushings are made of high temperature polymer.

20. The “no lube” conveyor chain of claim 18 in which said load wheel and said guide wheel rotate with their axels which extend through said axel openings, fitted with polymeric bushings at their ends.
